(19) United States
(12) Patent Application Publication
(10) Pub. No.: US 2024/0363836 A1
(43) Pub. Date: Oct. 31, 2024

(54) ANODE ACTIVE MATERIAL FOR ALL-SOLID-STATE BATTERY

(71) Applicants: Hyundai Motor Company, Seoul (KR); Kia Corporation, Seoul (KR)

(72) Inventors: Ga Hyeon Im, Hwaseong (KR); Yun Sung Kim, Seoul (KR); Yoon Kwang Lee, Suwon (KR); Kyu Joon Lee, Hwaseong (KR); So Young Lee, Suwon (KR); Hong Seok Min, Yongin (KR)

(21) Appl. No.: 18/530,061

(22) Filed: Dec. 5, 2023

(30) Foreign Application Priority Data
Apr. 27, 2023 (KR) 10-2023-0055389

(51) Int. Cl. H01M 4/36; H01M 4/04; H01M 4/38; H01M 4/587

(52) U.S. Cl. CPC H01M 4/366; H01M 4/0428; H01M 4/386; H01M 4/587; H01M 2004/021; H01M 2004/027; H01M 2220/20

(57) ABSTRACT

Disclosed are an anode active material for an all-solid-state battery in which a lithophilic material is deposited in and on particles.

### CROSS REFERENCE TO RELATED APPLICATION

The present application claims priority to Korean Patent Application No. 10-2023-0055389, filed Apr. 27, 2023, the entire contents of which is incorporated herein for all purposes by this reference.

### TECHNICAL FIELD

The present disclosure relates to an anode active material for an all-solid-state battery in which a lithophilic material is deposited in and on particle.

### BACKGROUND

A lithium secondary battery is configured to include cathode and anode materials that enable movement of lithium ions therebetween and an electrolyte that is responsible for transporting lithium ions.

Conventional batteries include a separator to prevent physical contact between a cathode and an anode for short circuit prevention. Among other things, an all-solid-state battery includes a solid electrolyte that replaces the roles of a separator and a liquid electrolyte. Therefore, an all-solid-state battery has a very low risk of explosion and thus has higher safety. Moreover, a solid electrolyte theoretically has faster ion transfer characteristics than a liquid electrolyte, so that all-solid-state batteries is considered as next-generation high-power and high-energy batteries.

In an all-solid-state battery, all components are solid, such that electrons and ions are transferred through interfaces between particles. Therefore, interfaces between materials have a dominant effect on battery characteristics. With the goal of solving this problem, the transfer of ions and electrons at interfaces has to be controlled, during which reversible reaction of storage and deintercalation of lithium ions is required. In particular, in graphite-based materials, it is absolutely necessary to solve these problems.

### SUMMARY

In preferred aspects, the present disclosure provides an anode for an all-solid-state battery, and particularly, the anode may have excellent lithium-ion conductivity and storability.

Further, the present disclosure provides an anode for an all-solid-state battery, and particularly, the anode may have high energy density and good life cycle characteristics.

A term “all-solid-state battery” as used herein refers to a rechargeable secondary battery that includes an electrolyte in a solid state for transferring ions between the electrodes of the battery.

In an aspect, provided is an anode active material for an all-solid-state battery and the anode active material may include: a particle including a plurality of flake carbon fragments overlapped in multiple layers; a first material loaded in a space between the plurality of the flake carbon fragments and having lithiophilic property; and a second material applied onto at least a portion of a surface of the particle and having lithiophilic property.

As used herein, the term “lithiophilic” refers to a material property that has affinity or be attracted toward lithium component (e.g., lithium ion). Often, a lithiophilic material, particular, lithiophilic metal, by forming an alloy or complex with lithium, can be used to control nucleation sites and stabilize Li (Li ion) deposition (e.g., dendrite) via regulation of nucleation overpotential of Li. Exemplary lithiophilic material (e.g., metal) may include lithium (Li), indium (In), gold (Au), silver (Ag), bismuth (Bi), zinc (Zn), aluminum (Al), iron (Fe), tin (Sn), and titanium (Ti).

In certain embodiments, the flake carbon fragments may be in a scale shape (e.g., scaly carbon fragment) or a film shape so those fragment can be layered or staggered with overlapping regions to form a particular shape.

Within a cross section of the anode active material, a ratio of the area of the particle to a sum of the areas of the first material and the second material may be in a range of about 5:5 to 8:2.

The anode active material may include (i) a core portion provided at the center of the cross section and having a quarter of the total area of the cross section; and (ii) a periphery portion being a remaining area other than the core portion. An area of the first material may be about 30% to 60% of the total area of the core portion.

The anode active material may include (i) a core portion provided at the center of the cross section and having a quarter of the total area of the cross section; and (ii) a periphery portion being a remaining area other than the core portion. A sum of the areas of the first material and the second material may be about 20% to 40% of the total area of the periphery portion.

The anode active material may have a moisture content in a range of about 1 ppm to 50 ppm. The anode active material may have an L value in a range of about 44 to 70, an a value in a range of about −0.5 to −0.1, and a b value in a range of about −6 to 0 in an L*a*b*-coordinate color system.

The anode active material may have a specific surface area in a range of about 0.5 m²/g to 4 m²/g.

The shortest distance between one flake carbon fragment and another adjacent flake carbon fragment is about 10 nm to 100 nm.

The first material may occupy about 80% or greater of the space between the flake carbon fragments.

The first material may suitably include one or more selected from the group consisting of silver (Ag), magnesium (Mg), aluminum (Al), gallium (Ga), zinc (Zn), bismuth (Bi), tin (Sn), indium (In), antimony (Sb), lead (Pb), silicon (Si), and germanium (Ge); or an alloy thereof with lithium.

The first material may include silicon (Si) or an alloy of silicon (Si) and lithium, and the first material may be amorphous.

The second material may cover about 90% or greater of the surface of the particles.

The second material may have a thickness in a range of about 10 nm to 1,000 nm.

The second material may suitably include one or more selected from the group consisting of silver (Ag), magnesium (Mg), aluminum (Al), gallium (Ga), zinc (Zn), bismuth (Bi), tin (Sn), indium (In), antimony (Sb), lead (Pb), silicon (Si), germanium (Ge), and combinations thereof, or an alloy thereof with lithium.

The second material may suitably include silicon (Si), or an alloy of silicon (Si) and lithium, and the second material may be amorphous.

The anode active material may have an average particle diameter (D50) in a range of about 1 μm to 20 μm.

The anode active material may suitably include an amount of about 40 wt % to 90 wt % of the particle and an amount of about 10 wt % to 60 wt % of a sum of the first material and the second material. The wt % based on the total weight of the anode active material.

In one aspect, provided is an anode of an all-solid-state battery including the anode active material as described herein.

In another aspect, provided is an all-solid-state battery including the anode active material as described herein.

Also provided is a vehicle including the all-solid-state battery as described herein.

Further provided herein is a method of producing the anode active material as described herein. For example, the method may include steps of forming the particle in a predetermined shape by stacking or overlapping the plurality of the flake carbon fragments in multiple layers; and depositing the second material on the surface of the particle and depositing the first second material.

According to various exemplary embodiments of the present disclosure, an anode for an all-solid-state battery, the anode having excellent lithium ion conductivity and storage properties, can be obtained.

According to various exemplary embodiments of the present disclosure, an anode for an all-solid-state battery, the anode having high energy density and good life cycle characteristics, can be obtained.

Other aspects of the invention are disclosed infra.

### BRIEF DESCRIPTION OF THE DRAWINGS

FIG. 1 shows an exemplary all-solid-state battery according to an exemplary embodiment of the present disclosure;

FIG. 2 shows an exemplary anode active material according to an exemplary embodiment of the present disclosure;

FIG. 3 shows an exemplary particle included in the anode active material;

FIG. 4 shows movement of lithium ions (Li⁺) between an exemplary anode active material and an exemplary solid electrolyte in an anode according to the present disclosure;

FIG. 5A shows the anode active material at the beginning of charging, and FIG. 5B shows the anode active material during charging;

FIG. 6 shows an exemplary anode active material according to an exemplary embodiment of the present disclosure;

FIG. 7 shows a primary particle included in the anode active material;

FIG. 8 shows a cross-sectional view taken along line A-A′ of FIG. 7;

FIG. 9 shows a cross-sectional view of the anode active material of FIG. 6;

FIG. 10 shows a result of analysis performed with a scanning electron microscope (SEM) for a cross section of an anode active material according to Preparation Example 1;

FIG. 11 shows a result of analysis performed with a scanning electron microscope (SEM) for a cross section of an anode active material according to Preparation Example 2;

FIG. 12 shows a core portion A and a periphery portion B of the anode active material according to the present disclosure;

FIG. 13A shows a position of the core portion A in an anode active material prepared according to Preparation Example 1, and FIG. 13B shows a position of the core portion A in an anode active material prepared according to Preparation Example 2;

FIG. 14 shows an exemplary device capable of measuring the dynamic angle of repose;

FIG. 15 shows an example of the dynamic angle of repose;

FIGS. 16A-16B show results of scanning the surface of a layer according to Comparative Preparation Example 1, using a laser confocal microscope;

FIGS. 17A-17B show results of scanning the surface of a layer according to Preparation Example 1, using a laser confocal microscope;

FIGS. 18A-18B show results of scanning the surface of a layer according to Preparation Example 2, using a laser confocal microscope;

FIG. 19 shows a cross-section curve and a roughness curve of a layer according to Comparative Preparation Example 1;

FIG. 20 shows a cross-section curve and a roughness curve of a layer according to Preparation Example 1;

FIG. 21 shows a cross-section curve and a roughness curve of a layer according to Preparation Example 2;

FIG. 22 shows an X-ray spectroscopic analysis for an anode according to Example 1;

FIG. 23 shows the first charge/discharge curve of a half-cell including an anode according to Example 1;

FIG. 24 shows the first charge/discharge curve of a half-cell including an anode according to Comparative Example 1;

FIG. 25 shows a high-rate charge/discharge curve of a half-cell including an anode according to Example 1;

FIG. 26 shows a high-rate charge/discharge curve of a half-cell including an anode according to Comparative Example 1;

FIG. 27 shows the capacity retention rate of a full cell according to Comparative Example 2; and

FIG. 28 shows the capacity retention rate of a full cell according to Example 2.

### DETAILED DESCRIPTION

Above objectives, other objectives, features, and advantages of the present disclosure will be readily understood from the following preferred embodiments associated with the accompanying drawings. However, the present disclosure is not limited to the embodiments described herein and may be embodied in other forms. The embodiments described herein are provided so that the disclosure can be made thorough and complete and that the spirit of the present disclosure can be fully conveyed to those skilled in the art. Throughout the drawings, like elements are denoted by like reference numerals. In the accompanying drawings, the dimensions of the structures are larger than actual sizes for clarity of the present disclosure. Terms used in the specification, “first”, “second”, etc., may be used to describe various components, but the components are not to be construed as being limited to the terms. These terms are used only for the purpose of distinguishing a component from another component. For example, without departing from the scope of the present disclosure, a first component may be referred as a second component, and a second component may be also referred to as a first component. As used herein, the singular forms “a”, “an”, and “the” are intended to include the plural forms as well unless the context clearly indicates otherwise. It will be further understood that the terms “comprises”, “includes”, or “has” when used in this specification specify the presence of stated features, regions, integers, steps, operations, elements and/or components, but do not preclude the presence or addition of one or more other features, regions, integers, steps, operations, elements, components and/or combinations thereof. It will also be understood that when an element such as a layer, film, area, or sheet is referred to as being “on” another element, it can be directly on the other element, or intervening elements may be present therebetween. Similarly, when an element such as a layer, film, area, or sheet is referred to as being “under” another element, it can be directly under the other element, or intervening elements may be present therebetween. Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles. In certain preferred aspects, a vehicle may be electric-powered, including a hybrid vehicles, plug-in hybrids, or vehicles where electric power is the primary or sole power source.

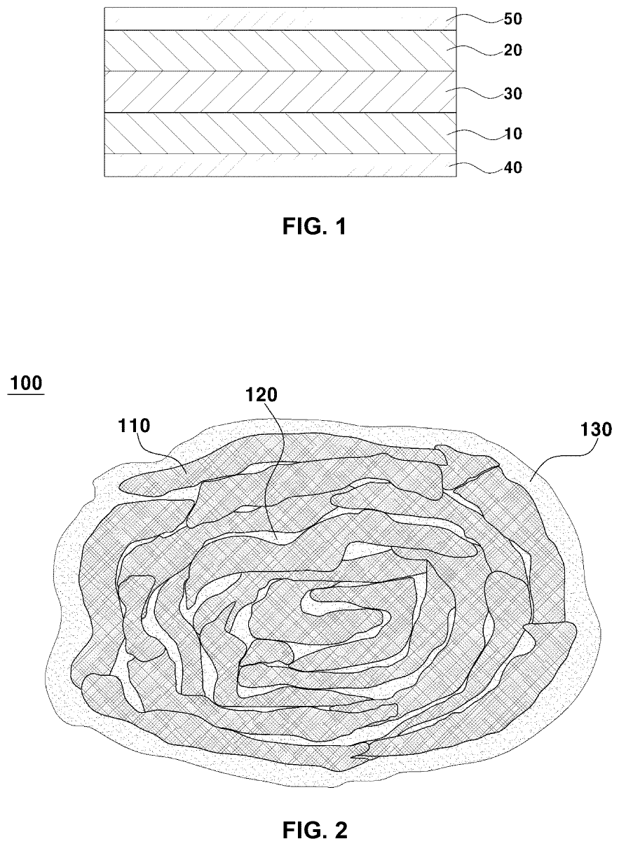

FIG. 1 shows an exemplary all-solid-state battery according to an exemplary embodiment of the present disclosure. The all-solid-state battery may include an anode 10, a cathode 20, and a solid electrolyte layer 30 interposed between the anode 10 and the cathode 20. An anode current collector 40 may be attached to the anode 10, and a cathode current collector 50 may be attached to the cathode 20.

The anode 10 may be provided in the form of a sheet having at least two opposing main surfaces. Each of the two main surfaces may include not only a mathematical plane, but also a certain curved surface in part, and may have irregularities generated in the manufacture of the anode 10. As such, the sheet shape is not limited to a relatively thin cuboid.

For the anode 10 in sheet form, the distance between two opposing main surfaces may be the thickness of the anode 10. The length of the anode 10 in the first direction (e.g. width direction) orthogonal to the thickness direction is greater than the thickness. Also, the length of the anode 10 in the second direction (e.g. longitudinal direction) orthogonal to each of the thickness direction and the first direction is greater than the thickness.

The thickness of the anode 10 is not particularly limited, but may be about 1 μm to 100 μm. The thickness of the anode 10 may indicate an average value when measuring a measurement target on a 5-point scale. Also, the thickness of the anode 10 may indicate the thickness when the all-solid-state battery is discharged.

The anode 10 may include an anode active material, a solid electrolyte, a binder, and the like.

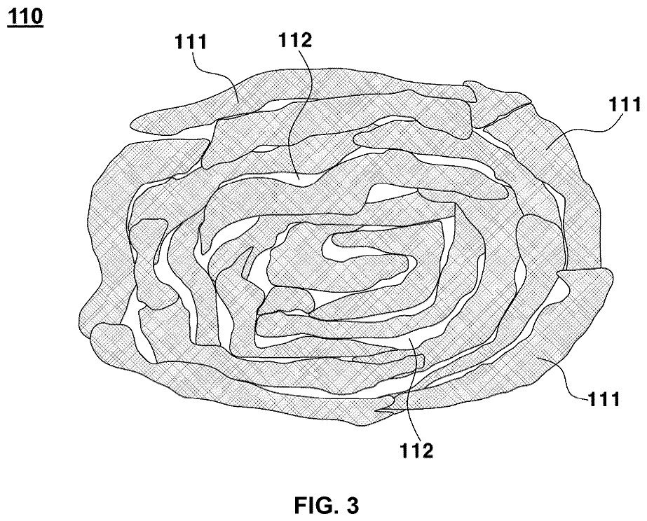

FIG. 2 shows an exemplary anode active material 100 according to an exemplary embodiment of the present disclosure. The anode active material 100 may include particle 110 forming a predetermined shape, a first material 120 loaded in the particle 110 and having lithiophilic property, and a second material 130 applied onto at least a portion of the surface of the particle 110 and having lithiophilic property.

A conventional all-solid-state battery includes a graphite-based anode active material. Lithium ions (Li⁺) are intercalated into and deintercalated from the graphite-based anode active material as charging and discharging proceed. In a lithium ion battery using a liquid electrolyte, since inside and outside of the graphite-based anode active material are impregnated with the liquid electrolyte, there is no problem in movement of lithium ions. However, in an all-solid-state battery using a solid electrolyte, lithium ions are efficiently conducted at the contact portion between the surface of the graphite-based anode active material and the solid electrolyte, but only diffusion-induced movement is possible inside the graphite-based anode active material, and thus the transfer path of lithium ions becomes very long. Specifically, at room temperature or low temperatures at which the movement speed by diffusion is low, power output of the all-solid-state battery is very low, and lithium is easily precipitated, which is undesirable.

Also, in the conventional all-solid-state battery, a solid electrolyte interphase layer is formed through oxidation/reduction reaction of carbon, solid electrolyte, lithium ions (Li⁺), and electrons at the interface between the graphite-based anode active material and the solid electrolyte. The solid electrolyte interphase layer induces depletion of lithium in the battery and hinders intercalation and deintercalation of lithium ions (Li⁺). Moreover, the solid electrolyte interphase layer induces formation of lithium dendrites on the surface of the solid electrolyte, shortening the lifespan of the battery.

The present disclosure aims to solve the problems with the conventional graphite-based anode active material described above, and by sufficiently depositing materials having lithiophilic property in and on the particles 110, lithium ion conductivity inside the anode active material 100 is increased, and side reaction between the particles 110 and the solid electrolyte is prevented by evening the interface between the anode active material 100 and the solid electrolyte, which will be described later.

FIG. 3 shows an exemplary particle 110 according to an exemplary embodiment of the present disclosure. The particle 110 may include flake carbon fragments 111 overlapped in multiple layers and a space 112 between the scaly carbon fragments.

The particles 110 each may be configured such that the flake carbon fragments 111 are assembled in a concentric shape, e.g., cabbage shape, or randomly. Although the particle 110 of FIG. 3 is spherical, the shape of the particles 110 is not limited thereto, and the particles 110 may have an elliptical shape, a rod shape, etc.

The flake carbon fragments 111 may be thin plate-like pieces having the same shape as scales.

A shortest distance between one flake carbon fragment and another adjacent flake carbon fragment may be about 10 nm to 100 nm. Here, the shortest distance may indicate a distance between one layer and another layer formed by the flake carbon fragments 111 when forming multiple layers by stacking the flake carbon fragments 111. Also, the shortest distance may indicate the size of the space 112 based on the cross section of the flake carbon fragments 111. When the shortest distance is less than about 10 nm, it may be difficult for the first material 120 to be deposited in the space 112. When the shortest distance is greater 20 than about 100 nm, conductivity of lithium ions (Li⁺) in the anode active material 100 may deteriorate.

The space 112 may be a pore in the particles 110 generated in the process of forming particles by overlapping the flake carbon fragments 111 in multiple layers. The space 112 may be formed continuously or intermittently from the surface of the particles 110 to the center of the particles 110.

The space 112 between the flake carbon fragments 111 may be filled with the first material 120. Also, the first material 120 may include a metal or metalloid having lithiophilic property. Here, lithiophilic property may indicate ability to form an alloy with lithium. The lithium alloy may attract lithium ions (Li⁺) to increase the diffusion speed of the lithium ions (Li⁺).

As described above, the space 112 may be continuously formed from the surface of the particles 110 to the center of the particles 110, and thus, when the space 112 is filled with the first material 120, lithium ions (Li⁺) may move more easily in the anode active material 100. Therefore, even when the all-solid-state battery according to the present disclosure operates at room temperature or low temperatures, problems such as power output degradation, excessive lithium precipitation, etc. may not occur, which will be described later.

The first material 120 may occupy about 80% or greater of the space 112 based on the total volume of the space 112. When the rate of filling with the first material 120 is less than about 80%, movement of lithium ions (Li⁺) inside the anode active material 100 may be inefficient. The upper limit of the rate of filling with the first material 120 is not particularly limited, and may be about 100% or less, about 99% or less, about 95% or less, or about 90% or less.

The first material 120 may suitably include one or more selected from the group consisting of silver (Ag), magnesium (Mg), aluminum (Al), gallium (Ga), zinc (Zn), bismuth (Bi), tin (Sn), indium (In), antimony (Sb), lead (Pb), silicon (Si), and germanium (Ge); or an alloy thereof with lithium.

Preferably, the first material 120 may include silicon (Si) or an alloy of silicon (Si) and lithium. The first material 120 may suitably include amorphous silicon (Si), or an alloy of amorphous silicon (Si) and lithium. Since amorphous silicon undergoes isotropic expansion, deformation and detachment of the first material 120 may be minimized, and transfer of lithium ions (Li⁺) between the first material 120 and the particles 110 may become easy.

The second material 130 may cover at least a portion of the surface of the particles 110. The second material 130 may prevent the particles 110 from contacting the solid electrolyte. When the particles 110 are exposed to the outside and contact the solid electrolyte, the solid electrolyte may be decomposed due to high electron conductivity of the particles 110.

The second material 130 may include a metal or metalloid having lithium affinity. Since the second material 130 covers most of the surface of the particles 110, lithium ions (Li⁺) conducted through the solid electrolyte may be rapidly intercalated into the anode active material 100 compared to when the second material 130 is absent. This is because the second material 130 transfers lithium ions (Li) faster than the particles 110.

The second material 130 may cover about 90% or greater of the entire surface area of the particles 110. The upper limit of the coverage of the second material 130 is not particularly limited, and may be about 100% or less, about 99% or less, or about 95% or less.

The second material 130 may have a thickness of about 20 nm to 1,000 nm. The thickness of the second material 130 may be measured using, for example, a transmission electron microscope (TEM). The use of a large number of samples is preferable. For example, the thickness of the second material 130 formed in 10 or more, preferably 100 or greater anode active materials 100 may be measured and calculated as an average value. When the thickness thereof is less than about 20 nm, the second material 130 may not sufficiently cover the surface of the particles 110. When it is greater than about 1,000 nm, productivity may deteriorate and properties of the anode active material 100 may be adversely affected.

The second material 130 may suitably include one or more selected from the group consisting of silver (Ag), magnesium (Mg), aluminum (Al), gallium (Ga), zinc (Zn), bismuth (Bi), tin (Sn), indium (In), antimony (Sb), lead (Pb), silicon (Si), and germanium (Ge); or an alloy thereof with lithium.

Preferably, the second material 130 may include silicon (Si), or an alloy of silicon (Si) and lithium. The second material 130 may suitably include amorphous silicon (Si) or an alloy of amorphous silicon (Si) and lithium. Since amorphous silicon undergoes isotropic expansion, deformation and detachment of the second material 130 may be minimized, and transfer of lithium ions (Li⁺) between the second material 130 and the particles 110 may become easy.

The anode active material 100 may include about 40 wt % to 90 wt % of the particles 110 and about 10 wt % to 60 wt % of the sum of the first material 120 and the second material 130. The % by weight is based on the total weight of the anode active material. When the combined weight of the first material 120 and the second material 130 is less than about 10 wt %, the first material 120 may not sufficiently fill the space 112 or the second material 130 may not sufficiently cover the surface of the particles 110. On the other hand, when the combined weight of the first material 120 and the second material 130 is greater than about 60 wt %, the second material 130 may become excessively thick.

An average particle diameter (D50) of the anode active material 100 may be about 1 μm to 20 μm. The average particle diameter (D50) may be measured using a commercially available laser diffraction scattering-type particle size distribution analyzer, for example, a Microtrac particle size distribution analyzer. Alternatively, 200 particles may be randomly extracted from an electron micrograph and the average particle diameter thereof may be calculated. When the average particle diameter (D50) of the anode active material 100 is about 1 μm or greater, the density of the anode 10 may be increased, thus improving discharge capacity per volume, and when the average particle diameter thereof is 20 μm or less, charging and cycle characteristics may be improved.

The specific surface area of the anode active material 100 may be about 0.5 m²/g to 4 m²/g. The specific surface area may be measured using a BET (Brunauer-Emmett-Teller) method by nitrogen adsorption, and for example, a typical specific surface area measuring instrument (MOUNTECH's Macsorb HM (model 1210) or MicrotracBEL's Belsorp-mini) may be used. When the specific surface area thereof falls within the above numerical range, it may be advantageous to suppress volume expansion of the anode active material 100.

A method of manufacturing the anode active material 100 is not particularly limited. An anode active material 100 may be manufactured by preparing particles 110 each forming a predetermined shape by overlapping the flake carbon fragments 111 in multiple layers as shown in FIG. 3, and then depositing a metal or metalloid corresponding to the first material 120 and the second material 130 to the particles 110. The deposition may be, for example, chemical vapor deposition (CVD) or physical vapor deposition (PVD), and chemical vapor deposition is preferable in consideration of the rate of filling with the first material 120, the coverage of the second material 130, and the uniform thickness of the second material 130.

The anode 10 may include a solid electrolyte having lithium ion conductivity. The solid electrolyte may include an oxide-based solid electrolyte or a sulfide-based solid electrolyte. It is preferable to use a sulfide-based solid electrolyte having high lithium ion conductivity.

Examples of the sulfide-based solid electrolyte may suitably include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (in which m and n are positive numbers and Z is any one selected from among Ge, Zn, and Ga), Li₂S—GeS₂, Li₂S—SiS₂—Li₃PO₄, Li₂S—SiS₂—LiₓMO_{y} (in which x and y are positive numbers and M is any one selected from among P, Si, Ge, B, Al, Ga, and In), Li₁₀GeP₂S₁₂, and the like.

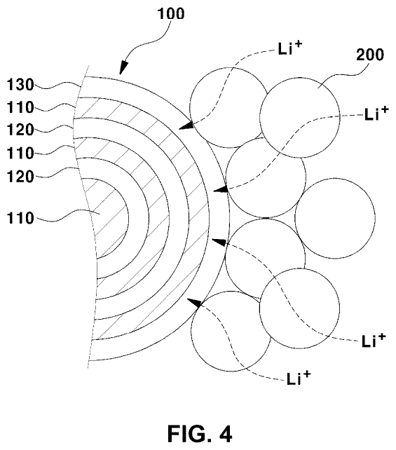

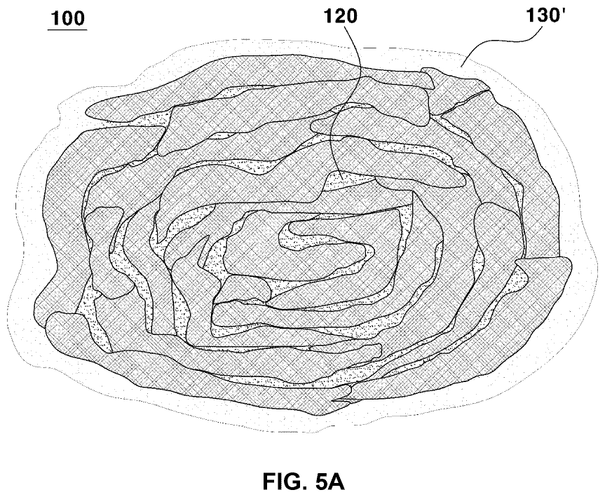

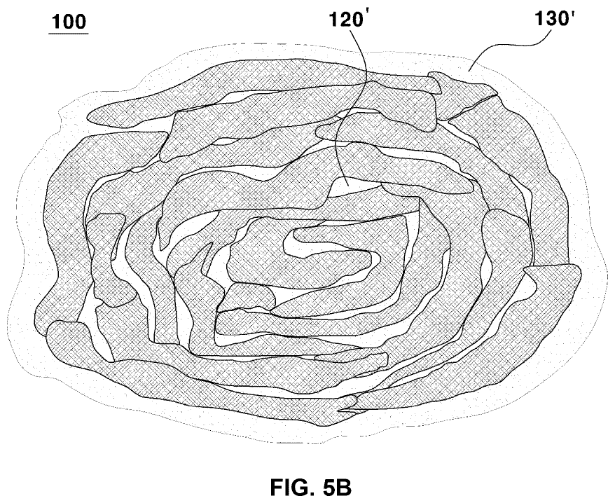

FIG. 4 shows movement of lithium ions (Li⁺) between the anode active material 100 and the solid electrolyte 200 in the anode 10 according to the present disclosure. FIG. 5A shows the anode active material 100 at the beginning of charging, and FIG. 5B shows the anode active material 100 during charging.

During charging of an all-solid-state battery, lithium ions (Li⁺) moved from the cathode 20 to the anode 10 are intercalated into the anode active material 100 through the solid electrolyte 200 having lithium ion conductivity in the anode 10.

Since the second material 130 covers most of the surface of the particles 110, the particles 110 may not come into contact with the solid electrolyte 200. Accordingly, a solid electrolyte interphase layer resulting from oxidation and reduction of the particles 110, the solid electrolyte 200, lithium ions (Li⁺), and electrons may not be present on the surface of the anode active material 100. The solid electrolyte interphase layer induces depletion of lithium in an all-solid-state battery and hinders intercalation and deintercalation of lithium ions (Li⁺). According to exemplary embodiments of the present disclosure, the problems described above may be solved by applying the second material 130 onto the surface of the particles 110.

As shown in FIGS. 4 and 5A, lithium ions (Li⁺) conducted to the anode active material 100 through the solid electrolyte 200 at the beginning of charging may react with the second material 130 to form an outer lithium alloy 130′.

When charging further progresses, the lithium ions (Li⁺) may diffuse into the anode active material 100. The lithium ions (Li⁺) are intercalated into the particles 110. The first material 120 with which the particles 110 are filled may react with the lithium ions (Li⁺) to form an inner lithium alloy 120′ as shown in FIG. 5B. The inner lithium alloy 120′ may serve as a transfer path of lithium ions (Li⁺), and the diffusion speed of the lithium ions (Li⁺) is increased.

Thereafter, lithium ions (Li⁺) are further diffused into the anode active material 100 and intercalated into the particles 110 until they reach the capacity of the particles 110, whereby charging is completed.

Since the transfer path of lithium ions (Li⁺) in the anode active material 100 is short and the diffusion thereof is fast, the all-solid-state battery according to the present disclosure may operate normally even at room temperature or low temperatures or with increased power output.

The anode 10 may include a binder. The binder may attach the anode active material 100 and the solid electrolyte 200 to each other.

The type of binder is not particularly limited, and examples thereof may suitably include butadiene rubber, nitrile butadiene rubber, hydrogenated nitrile butadiene rubber, polyvinylidene fluoride (PVDF), polytetrafluoroethylene (PTFE), carboxymethyl cellulose (CMC), and the like.

The anode 10 may include an amount of about 80 wt % to 85 wt % of the anode active material 100, an amount of about 10 wt % to 15 wt % of the solid electrolyte 200, and an amount of about 1 wt % to 5 wt % of the binder, based on the total weight of the anode. However, the amounts of individual components may be appropriately adjusted in consideration of the desired capacity and efficiency of an all-solid-state battery.

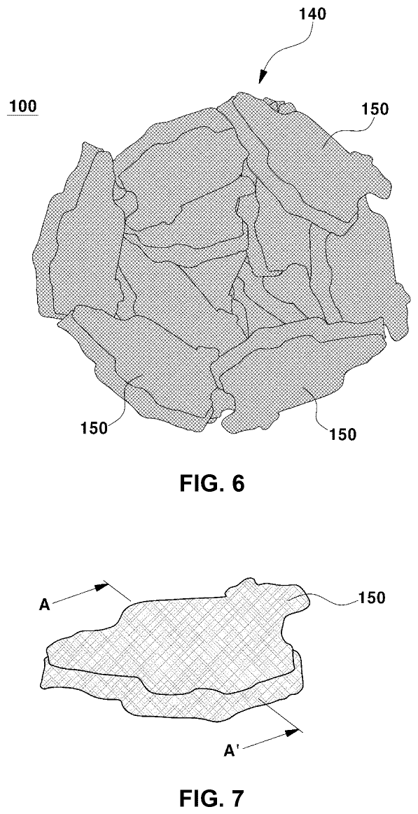

FIG. 6 shows an anode active material 100 according to an exemplary embodiment of the present disclosure. The anode active material 100 may include secondary particles 140 each configured such that primary particles 150 are overlapped in multiple layers and spheroidizied.

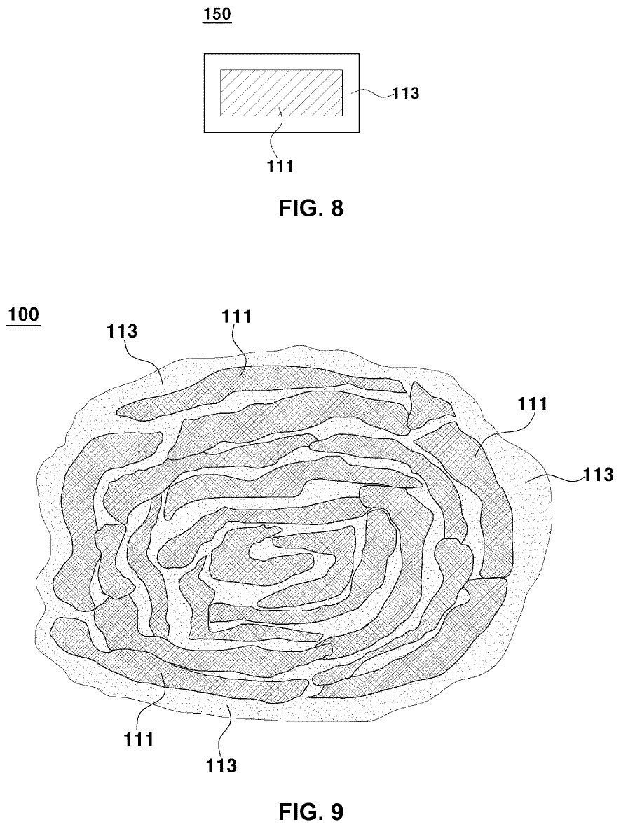

FIG. 7 shows a primary particle 150. FIG. 8 shows a cross-sectional view taken along line A-A′ of FIG. 7. FIG. 9 shows a cross-sectional view of the anode active material 100 of FIG. 6.

The secondary particles 140 each may be configured such that the primary particles 150 are assembled in a concentric shape, e.g., cabbage shape, or randomly. The secondary particle 140 of FIG. 6 is spherical, but the shape of the secondary particles 140 is not limited thereto, and the secondary particles 140 may have an elliptical shape, a rod shape, or the like.

The primary particles 150 each may include a flake carbon fragment 111 and a coating part 113 applied onto the surface of the flake carbon fragment 111 and including a lithiophilic material.

Since the flake carbon fragment 111 is described above, a detailed description thereof will be omitted below.

The coating part 113 may cover about 90% or greater of the surface of the flake carbon fragment 111. The upper limit of the coverage of the coating part 113 is not particularly limited, and may be about 100% or less, about 99% or less, or about 95% or less. When the coverage of the coating part 113 is 90% or more, as shown in FIG. 9, the inside and surface of the anode active material 100 may be sufficiently filled with and/or coated with a lithophilic material.

The coating part 113 may have a thickness of about 20 nm to 1,000 nm. The thickness of the coating part 113 may be measured using, for example, a transmission electron microscope (TEM). The use of a large number of samples is preferable. For example, the thickness of the coating part 113 formed in 10 or greater, preferably 100 or greater primary particles 150 may be measured and calculated as an average value.

The anode active material 100 may include an amount of about 40 wt % to 90 wt % of the flake carbon fragment 111 and an amount of about 10 wt % to 60 wt % of the coating part 113, based on the total weight of the anode active material. When the amount of the coating part 113 is less than about 10 wt %, it may be difficult to sufficiently fill and/or coat the inside and surface of the anode active material 100 with a lithiophilic material. When the amount thereof is greater than about 60 wt %, the coating part 113 may become excessively thick.

The coating part 113 may suitably include one or more selected from the group consisting of silver (Ag), magnesium (Mg), aluminum (Al), gallium (Ga), zinc (Zn), bismuth (Bi), tin (Sn), indium (In), antimony (Sb), lead (Pb), silicon (Si), and germanium (Ge); or an alloy thereof with lithium.

Preferably, the coating part 113 may suitably include silicon (Si), or an alloy of silicon (Si) and lithium. More preferably, the coating part 113 may include amorphous silicon (Si) or an alloy of amorphous silicon (Si) and lithium. Since amorphous silicon undergoes isotropic expansion, deformation and separation of the coating part 113 may be minimized, and transfer of lithium ions (Li⁺) between the coating part 113 and the flake carbon fragment 111 may become easy.

A method of manufacturing the anode active material 100 is not particularly limited. The anode active material 100 may be manufactured in a manner in which primary particles 150 are prepared by depositing a lithiophilic material on the surface of the flake carbon fragments 111, after which the primary particles 150 are overlapped in multiple layers and spheroidized to form secondary particles 140.

The cathode 20 may be provided in the form of a sheet having at least two opposing main surfaces. Each of the two main surfaces may include not only a mathematical plane, but also a certain curved surface in part, and may have irregularities generated in the manufacture of the cathode 20. As such, the sheet shape is not limited to a relatively thin cuboid.

For the cathode 20 in sheet form, the distance between two opposing main surfaces may be the thickness of the cathode 20. The length of the cathode 20 in the first direction (e.g. width direction) orthogonal to the thickness direction is greater than the thickness. Also, the length of the cathode 20 in the second direction (e.g. longitudinal direction) orthogonal to each of the thickness direction and the first direction is greater than the thickness.

The thickness of the cathode 20 is not particularly limited, but may be about 1 μm to 100 μm. The thickness of the cathode 20 may indicate an average value when measuring a measurement target on a 5-point scale. Also, the thickness of the cathode 20 may indicate the thickness when the all-solid-state battery is discharged.

The cathode 20 may include a cathode active material, a solid electrolyte, a conductive material, a binder, and the like.

The cathode active material is capable of occluding and releasing lithium ions.

The cathode active material may suitably include a rock-salt-layer-type active material such as LiCoO₂, LiMnO₂, LiNiO₂, LiVO₂, Li₁₊ₓNiCo_{1/3}Mn_{1/3}O₂, etc., a spinel-type active material such as LiMn₂O₄, Li(Ni_{0.5}Mn_{1.5})O₄, etc., an inverse-spinel-type active material such as LiNiVO₄, LiCoVO₄, etc., an olivine-type active material such as LiFePO₄, LiMnPO₄, LiCoPO₄, LiNiPO₄, etc., a silicon-containing active material such as Li₂FeSiO₄, Li₂MnSiO₄, etc., a rock-salt-layer-type active material in which a portion of a transition metal is substituted with a different metal, such as LiNi_{0.8}Co_{(0.2-x)}AlₓO₂ (0<x<0.2), a spinel-type active material in which a portion of a transition metal is substituted with a different metal, such as Li₁₊ₓMn_{2-x-y}M_{y}O₄ (M being at least one selected from among Al, Mg, Co, Fe, Ni, and Zn, (<x+y<2), lithium titanate such as Li₄Ti₅O₁₂, and the like.

The solid electrolyte may suitably include an oxide-based solid electrolyte or a sulfide-based solid electrolyte. It is preferable to use a sulfide-based solid electrolyte having high lithium ion conductivity. The sulfide-based solid electrolyte is not particularly limited, but examples thereof may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (in which m and n are positive numbers and Z is any one selected from among Ge, Zn, and Ga), Li₂S—GeS₂, Li₂S—SiS₂—Li₃PO₄, Li₂S—SiS₂—LiₓMO_{y} (in which x and y are positive numbers and M is any one selected from among P, Si, Ge, B, Al, Ga, and In), Li₁₀GeP₂S₁₂, and the like. The solid electrolyte included in the cathode 20 may be the same as or different from the solid electrolyte included in the anode 10.

Examples of the conductive material may suitably include carbon black, conductive graphite, ethylene black, graphene, and the like.

Examples of the binder may suitably include butadiene rubber, nitrile butadiene rubber, hydrogenated nitrile butadiene rubber, polyvinylidene fluoride (PVDF), polytetrafluoroethylene (PTFE), carboxymethyl cellulose (CMC), and the like. The binder included in the cathode 20 may be the same as or different from the binder included in the anode 10.

The solid electrolyte layer 30 may be provided in the form of a sheet having at least two opposing main surfaces. Each of the two main surfaces may include not only a mathematical plane, but also a certain curved surface in part, and may have irregularities generated in the manufacture of the solid electrolyte layer 30. As such, the sheet shape is not limited to a relatively thin cuboid.

For the solid electrolyte layer 30 in sheet form, the distance between two opposing main surfaces may be the thickness of the solid electrolyte layer 30. The length of the solid electrolyte layer 30 in the first direction (e.g. width direction) orthogonal to the thickness direction is greater than the thickness. Also, the length of the solid electrolyte layer 30 in the second direction (e.g. longitudinal direction) orthogonal to each of the thickness direction and the first direction is greater than the thickness.

The thickness of the solid electrolyte layer 30 is not particularly limited, but may be about 1 μm to 100 μm. The thickness of the solid electrolyte layer 30 may indicate an average value when measuring a measurement target on a 5-point scale.

The solid electrolyte layer 30 may include a solid electrolyte having lithium ion conductivity. The solid electrolyte may include at least one selected from the group consisting of an oxide-based solid electrolyte, a sulfide-based solid electrolyte, and combinations thereof. Also, the solid electrolyte may be crystalline, amorphous, or a mixed state thereof.

Examples of the oxide-based solid electrolyte may suitably include perovskite-type LLTO (Li₃ₓLa_{2/3-x}TiO₃), phosphate-based NASICON-type LATP (Li₁₊ₓAlₓTi₂₋ₓ(PO₄)₃), and the like.

Examples of the sulfide-based solid electrolyte may suitably include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSn (in which m and n are positive numbers and Z is any one selected from among Ge, Zn, and Ga), Li₂S—GeS₂, Li₂S—SiS₂—Li₃PO₄, Li₂S—SiS₂—LiₓMO_{y} (in which x and y are positive numbers and M is any one selected from among P, Si, Ge, B, Al, Ga, and In), Li₁₀GeP₂S₁₂, and the like.

Preferably, the solid electrolyte suitably includes a sulfide-based solid electrolyte having an argyrodite crystal structure. The sulfide-based solid electrolyte having the argyrodite crystal structure may include at least one selected from the group consisting of Li₇₋ₓPS₆₋ₓClₓ (0<x≤2), Li₇₋ₓPS₆₋ₓBrₓ (0<x≤2), Li₇₋ₓPS₆₋ₓIₓ (0<x≤2), and combinations thereof.

The anode current collector 40 may be a plate-like substrate having electrical conductivity. Specifically, the anode current collector 40 may be provided in the form of a sheet, a thin film, or a foil.

The anode current collector 40 may include a material that does not react with lithium. Specifically, the anode current collector 40 may include at least one selected from the group consisting of nickel (Ni), copper (Cu), stainless steel, and combinations thereof.

The thickness of the anode current collector 40 is not particularly limited, and may be, for example, about 1 μm to 500 μm.

The cathode current collector 50 may include a plate-like substrate having electrical conductivity. For example, the cathode current collector 50 may be provided in the form of a sheet, a thin film, or a foil.

The cathode current collector 50 may include aluminum foil.

The thickness of the cathode current collector 50 is not particularly limited, and may be, for example, about 1 μm to 500 μm.

### EXAMPLE

A better understanding of the present disclosure may be obtained through the following examples. These examples are merely set forth to illustrate the present disclosure, and are not to be construed as limiting the scope of the present disclosure.

### Preparation Example 1

Particles having a shape close to a spherical or elliptical shape were prepared by overlapping flake carbon fragments in multiple layers. Silicon was deposited in and on the particles through chemical vapor deposition. Specifically, the particles were placed in a chamber and the chamber was evacuated, after which a reactive gas containing silicon was injected into the chamber. The inside of the chamber was heated to a predetermined temperature, so that silicon contained in the reactive gas was deposited in and on the particles as a first material and a second material, respectively, thereby manufacturing an anode active material.

The anode active material according to Preparation Example 1 included an amount of about 90 wt % of the particles and an amount of about 10 wt % of the sum of the first material and the second material (silicon) based on the total weight of the anode active material.

### Preparation Example 2

An anode active material was prepared in the same manner as in Preparation Example 1, except that the anode active material was set to contain an amount of about 70 wt % of the particle and an amount of about 30 wt % of the sum of the first material and the second material (silicon) based on the total weight of the anode active material.

### Comparative Preparation Example 1

The particles of Preparation Example 1 to which silicon was not deposited were set as Comparative Preparation Example 1.

### Comparative Preparation Example 2

An anode active material was prepared in the same manner as in Preparation Example 1, except that the anode active material was set to contain an amount of about 95 wt % of the particle and an amount of about 5 wt % of the sum of the first material and the second material (silicon) based on the total weight of the anode active material.

Area Ratio of the Particles to Silicon within a Cross Section of the Anode Active Material

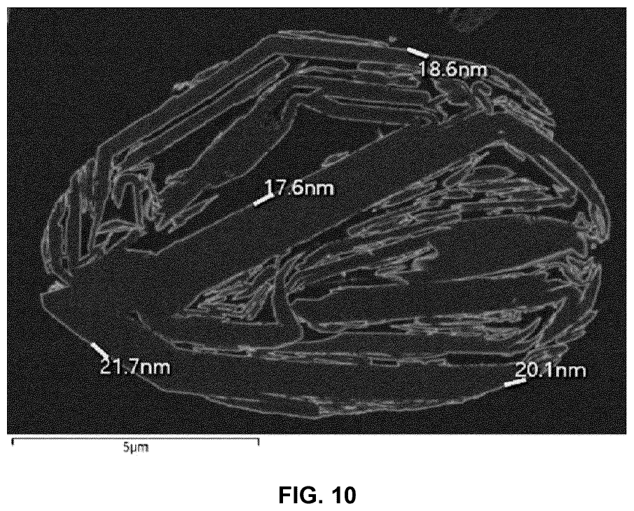

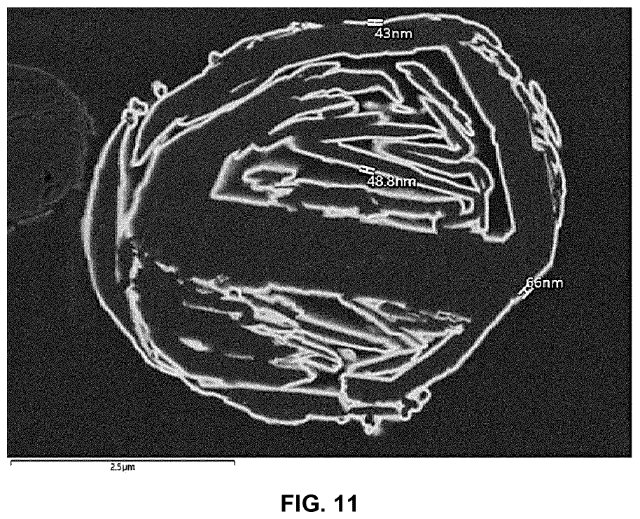

The area ratio may be a parameter for evaluating the filling rate, coverage, and the like of silicon. FIGS. 10 and 11 show results of analysis performed with a scanning electron microscope (SEM) for cross sections of the anode active materials according to Preparation Examples 1 and 2, respectively. Darkened areas may indicate the particles in which flake carbon fragments are structured, and brightened areas may indicate silicon (the first material and the second material). Referring to these results, the second material coating the surface of the particles and having a thickness in a range of 10 nm to 1,000 nm can be uniformly formed with little deviation in thickness.

The cross section of each anode active material may be analyzed by treating the anode active material with epoxy. Cutting the individual particles of the anode active material is difficult, so the anode active material and the epoxy are uniformly mixed and then thermally cured to form a lump in which a plurality of anode active materials aggregates. The lump was cut by ion milling (Arblade 5000 purchased from Hitachi). Then, the cross-sectional images were photographed with a scanning electron microscope (Regulus 8230 purchased from Hitachi), and the areas of the particles and silicon may be measured using software called Aztec Feature.

The area ratios of the particles to silicon (the first material and the second material) within the cross section of the anode active materials, prepared according to Preparation Examples 1 and 2, are shown in Table 1 below.

TABLE 1

| | Silicon content | Particle area | Silicon area |
|---|---|---|---|
| Classification | [wt %] | [%] | [%] |
| Preparation Example 1 | 10 | 71.34 | 28.66 |
| Preparation Example 2 | 30 | 54.83 | 45.17 |

As shown in Table 1, the area ratio of the particles to the silicon (the sum of the first material and the second material) was in a range of 5:5 to 8:2 within the cross section of the anode active material.

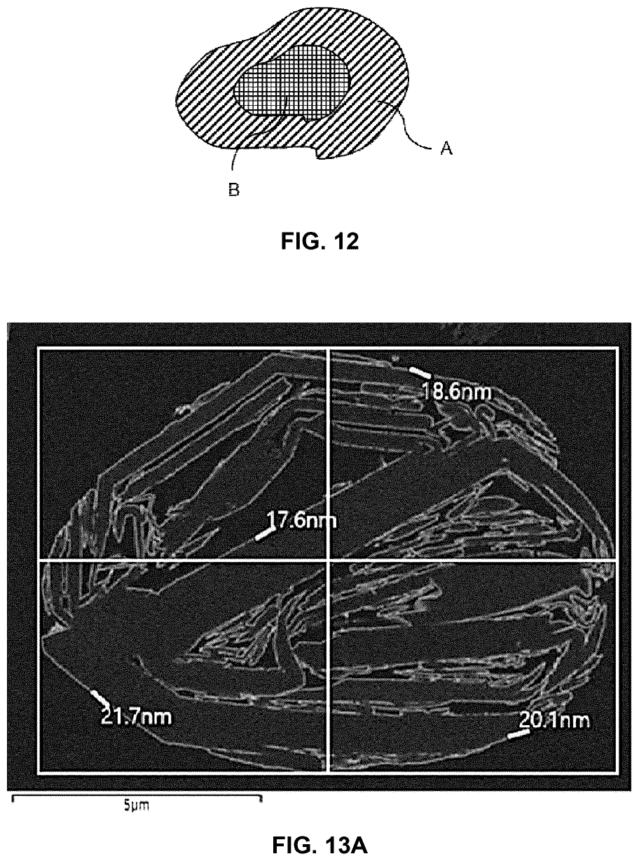

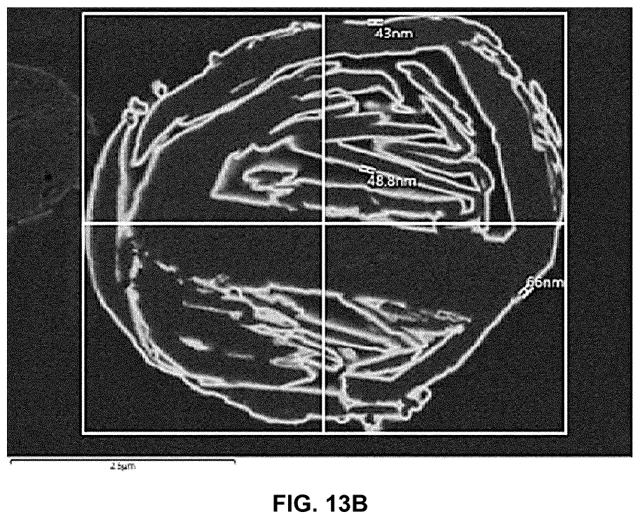

On the other hand, to examine changes in the distribution of silicon in the anode active material according to the deposition amount of silicon, the cross section of the anode active material was divided into a core portion and a periphery portion. Then, the areas of the particles and silicon in each portion were measured in the same manner as in the above method. FIG. 12 shows the core portion A and the periphery portion B of the anode active material. Specifically, the core portion A is positioned toward the center of the anode active material and has substantially the same outline as that of the cross section of the anode active material. However, the width and height thereof are each independently reduced by ½, so the area thereof may take up a quarter of the cross-sectional area of the anode active material. FIGS. 13A and 13B show the positions of the core portion A in the anode active materials prepared according to Preparation Examples 1 and 2, respectively. The core portion A may be divided by maintaining the outline shape of the anode active material, based on the center of a quadrangle circumscribed to the anode active material while reducing the size thereof so that the area becomes a quarter of the anode active material. The periphery portion B may refer to the remaining area other than the core portion A.

The area ratios of the particles and silicon (the first material and the second material) in the core portion and the periphery portion of the anode active material, prepared according to Preparation Examples 1 and 2, are shown in Table 2 below.

TABLE 2

| | | Silicon | Area of | Area of |
|---|---|---|---|---|
| | | content | particles | silicon |
| Classification | | [wt %] | [%] | [%] |
| Preparation | Core portion | 10 | 51.19 | 48.81 |
| Example 1 | Periphery portion | | 77.64 | 22.36 |
| Preparation | Core portion | 30 | 51.20 | 48.80 |
| Example 2 | Periphery portion | | 69.75 | 30.25 |

As shown in Table 2, in both Preparation Examples 1 and 2, the silicon content in the core portion A was greater than that in the periphery portion B. Specifically, the area of the first material may account for 30% to 60% of the area of the core portion A. Thus, diffusion of lithium ions (Li⁺) introduced into the anode active material may be facilitated as they move toward the inside of the anode active material.

On the other hand, the sum of the area of the first material and the second material (silicon) may account for 20% to 40% of the area of the periphery portion B. In addition, the higher the silicon content, the higher the silicon content in the periphery portion B. Thus, diffusion of the lithium ions (Li⁺) inside the anode active material may be further rapidly facilitated as the silicon content increases within an appropriate range.

### Dynamic Angle of Repose and Roughness of Anode Active Material

A dynamic angle of repose may be used to evaluate a coverage of the second material. As the coverage of the second material increases, the dynamic angle of repose tends to decrease. In addition, the higher the coverage of the second material, the lower the surface roughness because the internal pores of the particle are kept from being exposed, meaning that the flowability of the anode active material increases. When using an anode active material having a small dynamic angle of repose and a low roughness, an anode capable of being further uniformly distributed may be formed.

The dynamic angle of repose is one of the variables capable of evaluating powder fluidity. Fluidity refers to the ability of a powder to flow freely and uniformly in the form of individual particles. Having a small flow angle means that the attractive force between the particles is small and powder fluidity is good. The dynamic angle of repose, which is an angle of an inclined powder surface, with respect to a horizontal plane, formed in a cylindrical container when putting powder thereinto and rotating the container at a constant speed around the horizontal cylinder axis, is an angle of repose in a dynamic equilibrium state.

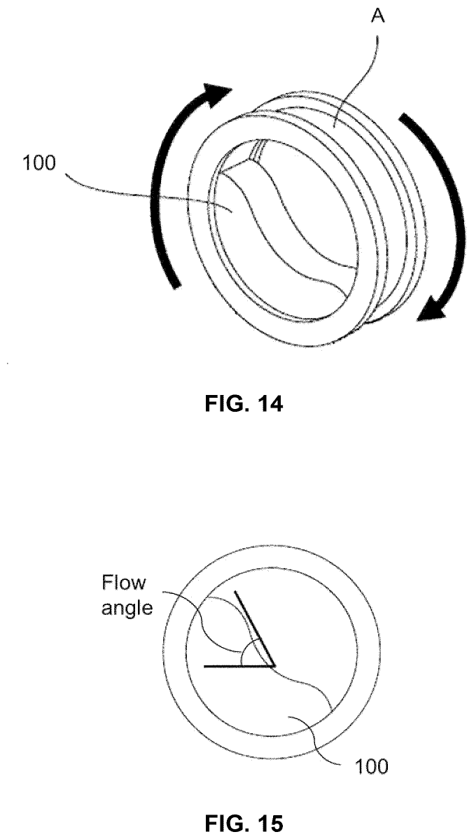

FIG. 14 shows an exemplary device capable of measuring the dynamic angle of repose. First, a predetermined amount of the anode active material 100 is put into a cylindrical drum D. The drum D rotates at a constant speed. As the drum rotates, a layer of the anode active material 100 is pulled upward. Then, an avalanche occurs when the balance between the attractive force between the particles of the anode active material 100 and the gravitational force is lost. The avalanche that periodically occurs in the rotating drum D is continuously photographed with a digital camera (not shown). Subsequently, an image analysis is performed on the photographed images for measurement. When the avalanche occurs as shown in FIG. 15, the angle of the inclined surface of the layer of the anode active material 100 to the ground may be obtained as a value of the dynamic angle of repose. The exemplary device capable of measuring the dynamic angle of repose may be a GranuDruM™ powder rheometer, and the results thereof may be analyzed using GranuTools™ software.

The rotation speed of the drum D is not particularly limited. For example, the drum D may rotate at a speed in a range of 1 rpm to 70 rpm or 4 rpm to 50 rpm.

In addition, the digital camera may photograph the anode active material 100 at an interval in a range of 500 ms to 1,000 ms.

The anode active materials according to Preparation Examples 1 and 2 and Comparative Preparation Example 1 were each independently loaded so that about 50% by volume of a 10 ml cylindrical transparent sample holder was occupied. After measuring 20 frames at an interval of 1,000 ms while increasing the rotation speed to 4 rpm, 8 rpm, 16 rpm, 30 rpm, 40 rpm, and 50 rpm, the average value of the flow angle at each rotation speed was selected as the dynamic angle of repose. The results thereof are shown in Table 3 below.

TABLE 3

| | | Flow angle [°] | | |
|---|---|---|---|---|
| | | Comparative | | |
| | | Preparation | Preparation | Preparation |
| Entry | | Example 1 | Example 1 | Example 2 |
| Drum rotation | 4 | 51.30 | 45.69 | 46.72 |
| speed [rpm] | 8 | 58.17 | 43.71 | 40.73 |
| | 16 | 57.86 | 42.45 | 42.10 |
| | 30 | 56.28 | 39.56 | 34.97 |
| | 40 | 47.09 | 38.38 | 35.13 |
| | 50 | 46.03 | 35.91 | 33.51 |

| | | | |
|---|---|---|---|
| Dynamic angle of repose [°] | 52.79 | 40.95 | 38.86 |
| Standard deviation | 4.954 | 3.323 | 4.716 |

As shown in Table 3, the higher the deposition amount of silicon compared to Comparative Preparation Example 1, the smaller the dynamic angle of repose. This means that as the surface of the particles was coated with silicon serving as the second material, the internal pores of the particle were kept from being exposed, and the surface roughness was reduced, thereby increasing the powder flowability. The anode active material, according to the present disclosure, had a dynamic angle of repose in a range of about 25° to 50°, which was less than that of the anode active material prepared in Comparative Preparation Example 1 not involving silicon deposition.

The roughness may refer to the surface roughness of the layer when forming any type of layer using the anode active material. The anode active materials, prepared according to Preparation Examples 1 and 2 and Comparative Preparation Example 1, were each independently put into a non-polar solvent along with a binder to prepare a slurry. Then, the slurry was applied onto a nickel-copper current collector to form a series of layers. The roughness of each layer was measured using a laser confocal microscope. A method using the laser confocal microscope, which is a non-contact roughness measurement method using a laser, enables a surface to be minutely scanned in a non-contact manner and enables an area that a probe cannot reach to be measured, unlike physical contact methods using a probe.

VK-X3000 series purchased from Keyence was used as the laser confocal microscope. The height display resolution thereof is lower than 1 nm, which makes the microscope extremely precise.

In the 3D images scanned using the laser confocal microscope, lines or areas were determined using software, and arithmetic average roughness (Ra), 10-point average roughness (Rz), and the ratio of the two (Rz/Ra) were measured through software-based calculation.

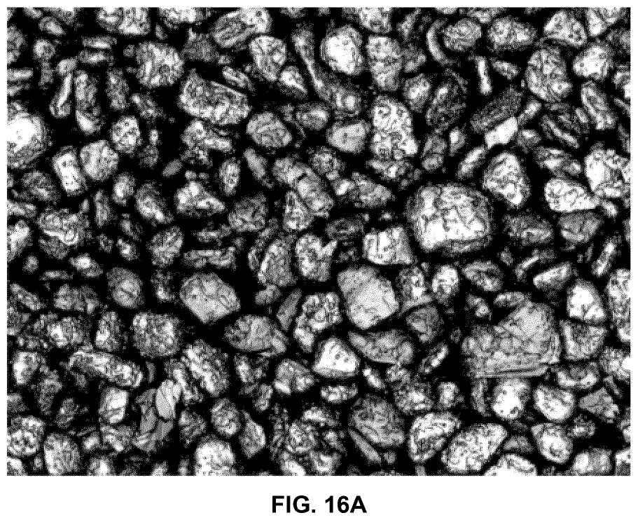

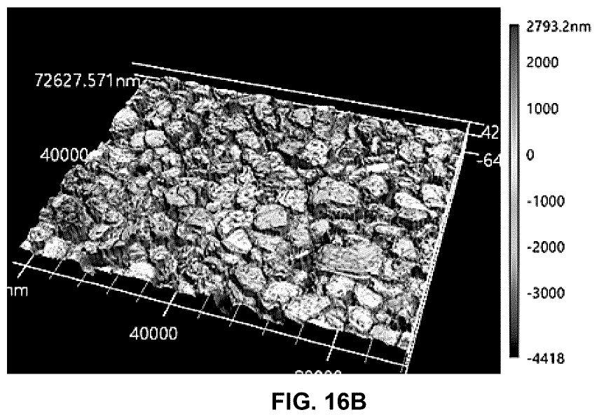

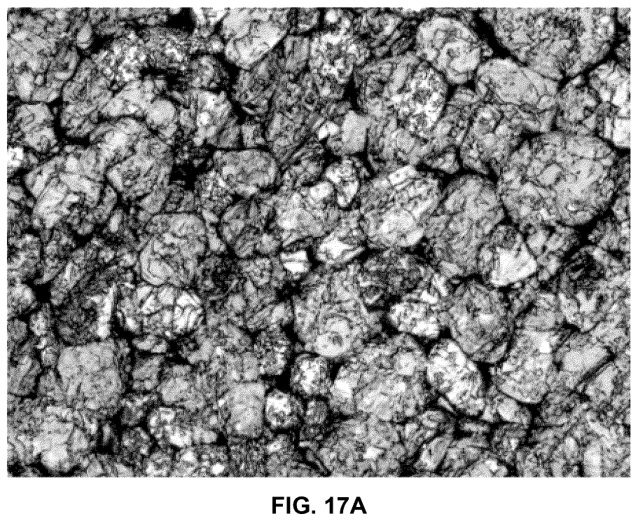

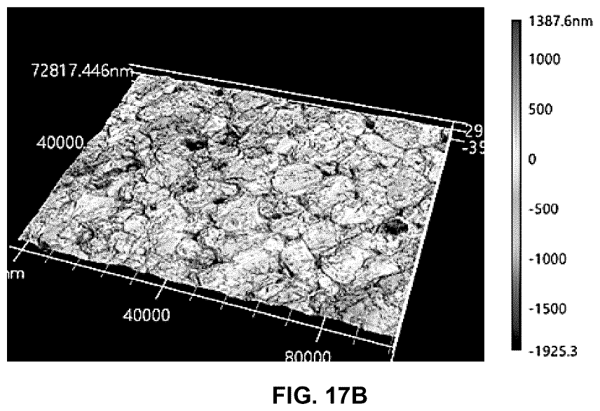

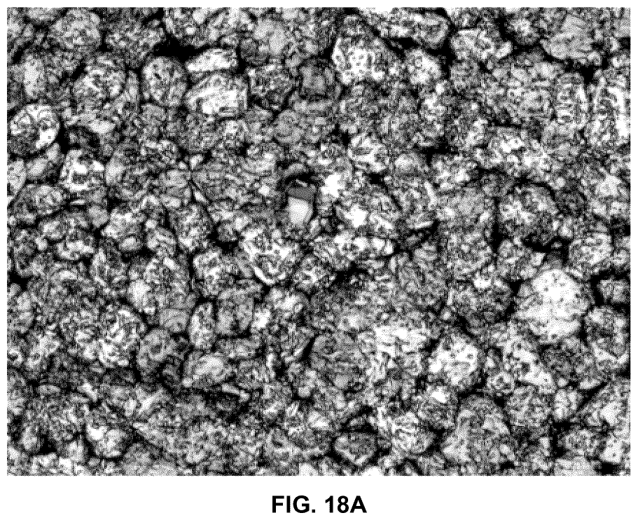

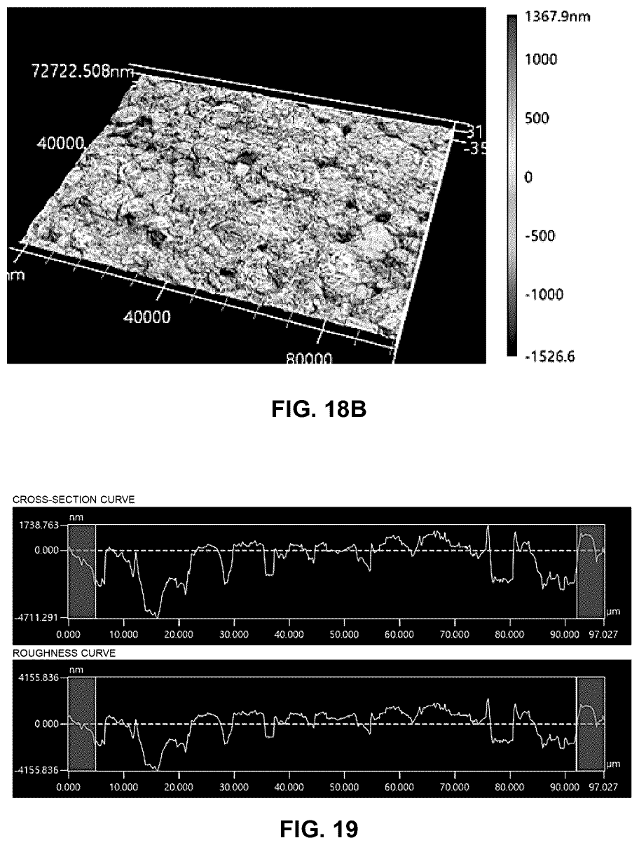

FIGS. 16A-16B, 17A-17B, and 18A-18B show the results of scanning the surfaces of the layers according to Comparative Preparation Example 1, Preparation Example 1, and Preparation Example 2, respectively, using the laser confocal microscope.

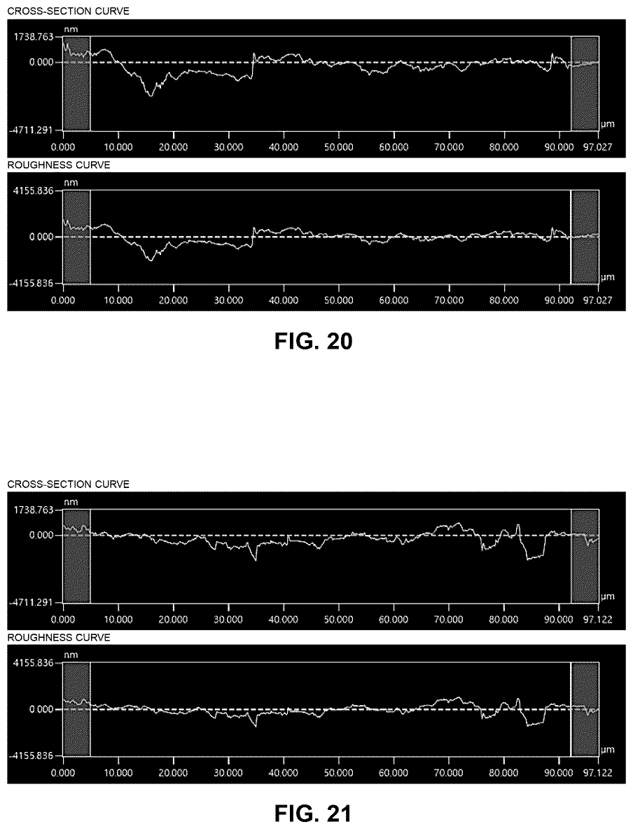

FIGS. 19, 20, and 21 show cross-section curves and roughness curves of the layers according to Comparative Preparation Example 1, Preparation Example 1, and Preparation Example 2, respectively.

The roughness values of the anode active materials, prepared according to Comparative Preparation Examples 1 and Preparation Examples 1 and 2, are shown in Table 4 below.

TABLE 4

| | Arithmetic average | 10-point average | |
|---|---|---|---|
| | roughness | roughness | |
| Classification | (Ra) [nm] | (Rz) [nm] | Rz/Ra |
| Comparative | 1,074.112 | 6,450.054 | 6.01 |
| Preparation Example 1 | | | |
| Preparation Example 1 | 449.758 | 3,234.432 | 7.19 |
| Preparation Example 2 | 374.200 | 2,611.363 | 6.98 |

The anode active materials, prepared according to Preparation Examples 1 and 2, may have a ratio (Rz/Ra) of 10-point average roughness (Rz) to arithmetic average roughness (Ra) in a range of 6.5 to 10, an arithmetic average roughness (Ra) in a range of 300 nm to 500 nm, and a 10-point average roughness (Rz) in a range of 2,000 nm to 4,000 nm.

As shown in FIGS. 19 to 21, as the silicon content increases, the curve of the measured cross section became flattened, which means that the surface roughness of the layer decreases. In addition, referring to Table 4, the higher the silicon content, the lower both the arithmetic average roughness and the 10-point average roughness. That is, when using the anode active material according to the present disclosure, a further uniform anode can be formed.

### Moisture Content

The moisture content of the anode active material was measured according to the silicon content. In addition to Preparation Examples 1 and 2 and Comparative Preparation Example 1, a material in which the anode active material of Preparation Example 1 was coated with carbon (hereinafter referred to as “Comparative Preparation Example 3”) was prepared. Each anode active material sample was heated to 120° C. using a Karl Fischer moisture titrator (860 KF purchased from Metrohm Co., Ltd.). Moisture generated from the anode active material was collected with a carrier gas and introduced into a titration solution. Dry air treated with a molecular sieve was used as the carrier gas. The measuring equipment measured the concentration of the titration solution to calculate the moisture content of the anode active material. The results thereof are shown in Table 5 below. The moisture content of each sample is the average value of 5 evaluations.

TABLE 5

| | Comparative | | Comparative | |
|---|---|---|---|---|
| | Preparation | Preparation | Preparation | Preparation |
| Entry | Example 1 | Example 1 | Example 3 | Example 2 |
| Moisture | 0.5 | 49.5 | 383.5 | 6.55 |
| content [ppm] | | | | |

The anode active materials, prepared according to Preparation Examples 1 and 2, may have a moisture content in a range of 1 ppm to 50 ppm. Comparative Preparation Example 3, in which the anode active material of Preparation Example 1 was coated with carbon, exhibited an extremely high moisture content. Therefore, Comparative Preparation Example 3 may cause side reactions in the anode and is likely to deteriorate battery performance. On the other hand, as the silicon content increased, the moisture content of the anode active material decreased.

### Color Coordinates

The brightness of the anode active material varies depending on silicon content, so the color coordinates of the anode active materials, prepared according to Preparation Examples 1 and 2 and Comparative Preparation Example 1, were measured. The anode active materials, prepared according to Preparation Examples 1 and 2 and Comparative Preparation Example 1, were each independently put into a non-polar solvent along with a binder to prepare a slurry. Then, the slurry was applied onto a nickel-copper current collector to form a series of layers. The color coordinate values of the surface of each layer were measured using X-rite Ci62, a portable colorimeter. The results thereof are shown in Table 6.

TABLE 6

| | Comparative Preparation | Preparation | Preparation |
|---|---|---|---|
| d65 | Example 1 | Example 1 | Example 2 |
| L* | 41.934 | 44.686 | 49.234 |
| a* | −0.05 | −0.127 | −0.266 |
| b* | −6.552 | −5.89 | −3.17 |

The anode active materials, prepared according to Preparation Examples 1 and 2, may have an L value in a range of 44 to 70, an a value in a range of −0.5 to −0.1, and a b value in a range of −6 to 0 in an L*a*b*-coordinate color system.

As shown in Table 6, the higher the silicon content, the brighter the anode active material. Specifically, as the silicon content increases, the L, a, and b values increased, decreased, and increased, respectively.

### Example 1

A slurry was prepared by adding the anode active material according to Preparation Example, a sulfide-based solid electrolyte, and a binder to a solvent. The slurry was applied onto an anode current collector to form an anode having a thickness of about 50 μm. Nitrile butadiene rubber (NBR) was used as the binder, and hexyl butyrate was used as the solvent.

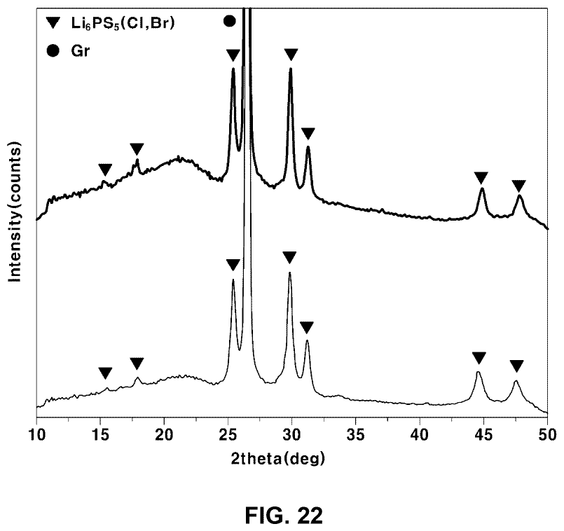

FIG. 22 shows results of X-ray spectroscopy of the anode according to Example 1, in which the lower result shows the anode immediately after manufacture, and the upper result shows the anode after 2 weeks. Peaks due to the solid electrolyte and the particles were observed, whereas peaks due to silicon were not observed, indicating that the silicon deposited to the anode active material was amorphous.

A half-cell was manufactured by stacking a solid electrolyte layer including a sulfide-based solid electrolyte on the anode and stacking lithium metal on the solid electrolyte layer.

### Comparative Example 1

A half-cell was constructed in the same manner as in Example 1 except for using the anode active material prepared according to Comparative Preparation Example 1.

### Test Example 1

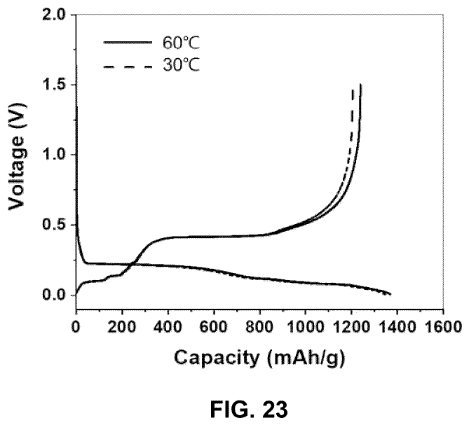

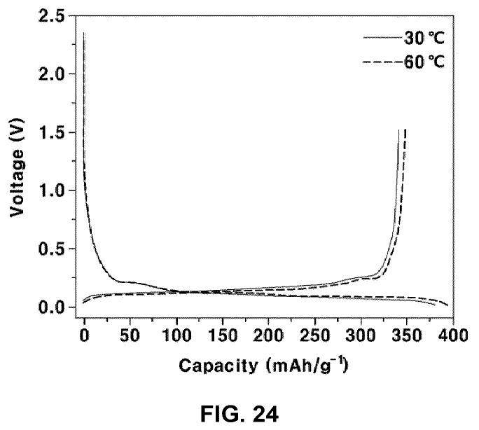

FIG. 23 shows first charge/discharge of the half-cell including the anode according to Example 1. FIG. 24 shows first charge/discharge of the half-cell including the anode according to Comparative Example 1. The characteristics thereof were evaluated at a temperature of 30° C. and 60° C.

Comparative Example 1 showed relatively high reactivity in the initial charging reaction (>0.5 V), corresponding to a reaction that forms an irreversible resistive layer, which was not observed in the results of Example 1.

When evaluated at a temperature of 30° C., the initial efficiency of Example 1 was about 91.8%, and the initial efficiency of Comparative Example 1 was about 89.5%. When evaluated at a temperature of 60° C., the initial efficiency of Example 1 was about 90.0%, and the initial efficiency of Comparative Example 1 was about 88.2%.

### Test Example 2

Charge/discharge characteristics were evaluated in the same manner as above at a current density increased to 2 mA/cm². The deposition capacity was set to 3.5 mAh/cm².

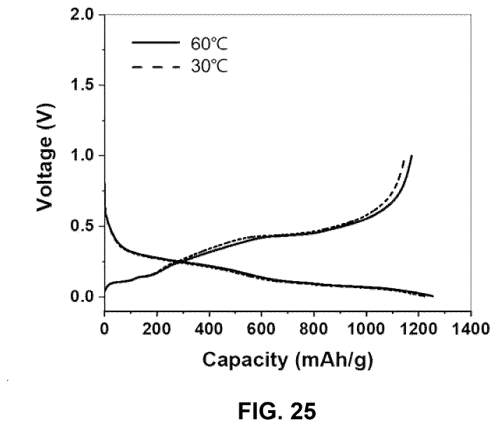

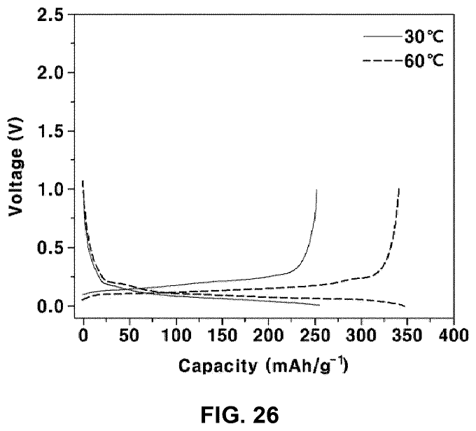

FIG. 25 shows high-rate charge/discharge of the half-cell including the anode according to Example 1. FIG. 26 shows high-rate charge/discharge of the half-cell including the anode according to Comparative Example 1. The characteristics thereof were evaluated at a temperature of 30° C. and 60° C. As shown in FIG. 26, Comparative Example 1 showed a great difference in capacity depending on temperature. At low temperatures at which lithium movement was limited, lithium intercalation was inefficient, which was caused by poor lithium movement between the surface of the particles and the solid electrolyte. Also, the solid electrolyte interphase layer formed at interfaces between the particles and the solid electrolyte may act as resistance and thus may hinder lithium movement.

As shown in FIG. 25, in Example 1, lithium was stored in the anode active material without great variation depending on temperature. This is deemed to be because the first material and the second material contribute to rapid movement of lithium into the anode active material.

### Example 2

A full cell was manufactured by stacking a solid electrolyte layer including a sulfide-based solid electrolyte on the anode according to Example 1 and stacking a cathode including a cathode active material, a solid electrolyte, a conductive material, and a binder on the solid electrolyte layer. Nickel-cobalt-manganese oxide was used as the cathode active material.

### Comparative Example 2

A full cell was manufactured in the same manner as in Example 2, with the exception that the anode active material according to Comparative Preparation Example 2 was used.

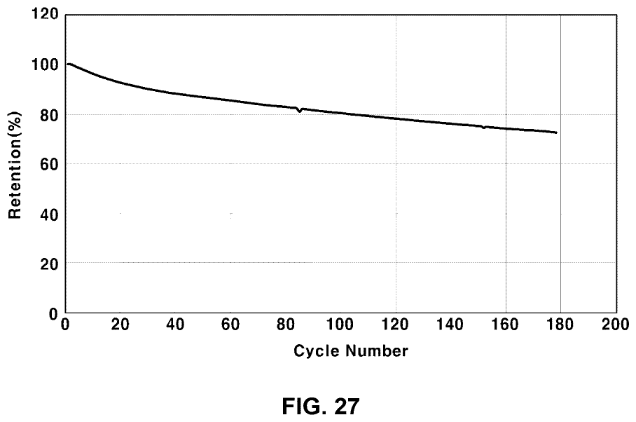

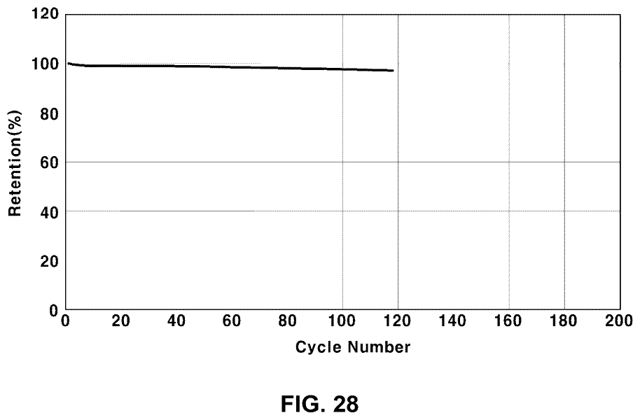

FIG. 27 shows results of measurement of the capacity retention of the full cell of Comparative Example 2. FIG. 28 shows results of measurement of the capacity retention of the full cell of Example 2. As such, Example 2, in which silicon was sufficiently deposited in and on the particles due to large amounts of the first material and the second material, exhibited a very high capacity retention and stable operation compared to Comparative Example 2.

As is apparent from the above description, according to various exemplary embodiments of the present disclosure, an anode for an all-solid-state battery having excellent lithium ion conductivity and storability can be obtained.

According to various exemplary embodiments of the present disclosure, an anode for an all-solid-state battery having excellent energy density and lifespan characteristics can be obtained.

The effects of the present disclosure are not limited to the above-mentioned effects. It should be understood that the effects of the present disclosure include all effects that can be inferred from the description of the present disclosure.

As the embodiments of the present disclosure have been described in detail above, the scope of the present disclosure is not limited to the above-described embodiments, and various modifications and improvements made by those skilled in the art using the basic concept of the present disclosure defined in the following claims are also within the scope of the present disclosure.

What is claimed is:

1. An anode active material for an all-solid-state battery, comprising:
a particle comprising a plurality of flake carbon fragments overlapped in multiple layers;
a first material loaded in a space between the plurality of the flake carbon fragments and having lithiophilic property; and
a second material applied onto at least a portion of a surface of the particle and having lithiophilic property,
wherein within a cross section of the anode active material, a ratio of the area of the particle to a sum of the areas of the first material and the second material is in a range of about 5:5 to 8:2.

2. The anode active material of claim 1, wherein the anode active material comprises a core portion provided in the center of the cross section of the anode active material and having a quarter of the total area of the cross section; and a periphery portion being a remaining area other than the core portion,
an area of the first material is about 30% to 60% of the total area of the core portion.

3. The anode active material of claim 1, wherein the anode active material comprises (i) a core portion provided in the center of the cross section of the anode active material and having a quarter of the total area of the cross section; and (ii) a periphery portion being a remaining area other than the core portion,
a sum of the areas of the first material and the second materials is about 20% to 40% of the total area of the periphery portion.

4. The anode active material of claim 1, wherein the active material has a moisture content in a range of about 1 ppm to 50 ppm.

5. The anode active material of claim 1, wherein the anode active material has an L value in a range of about 44 to 70, an a value in a range of about −0.5 to −0.1, and a b value in a range of v-6 to 0 in an L*a*b*-coordinate color system.

6. The anode active material of claim 1, wherein the anode active material has a specific surface area in a range of about 0.5 m²/g to 4 m²/g.

7. The anode active material of claim 1, wherein a shortest distance between one flake carbon fragment and another adjacent flake carbon fragment is about 10 nm to 100 nm.

8. The anode active material of claim 1, wherein the first material occupies about 80% or greater of the space between the flake carbon fragments.

9. The anode active material of claim 1,
wherein the first material comprises one or more selected from the group consisting of silver (Ag), magnesium (Mg), aluminum (Al), gallium (Ga), zinc (Zn), bismuth (Bi), tin (Sn), indium (In), antimony (Sb), lead (Pb), silicon (Si), and germanium (Ge); or an alloy thereof with lithium.

10. The anode active material of claim 1, wherein the first material comprises silicon (Si), or an alloy of silicon (Si) and lithium, and the first material is amorphous.

11. The anode active material of claim 1, wherein the second material covers about 90% or greater of the surface of the particles.

12. The anode active material of claim 1, wherein the second material has a thickness in a range of about 10 nm to 1,000 nm.

13. The anode active material of claim 1, wherein the second material comprises one or more selected from the group consisting of silver (Ag), magnesium (Mg), aluminum (Al), gallium (Ga), zinc (Zn), bismuth (Bi), tin (Sn), indium (In), antimony (Sb), lead (Pb), silicon (Si), and germanium (Ge); or an alloy thereof with lithium.

14. The anode active material of claim 1, wherein the second material comprises silicon (Si), or an alloy of silicon (Si) and lithium, and the second material is amorphous.

15. The anode active material of claim 1, wherein the anode active material has an average particle diameter (D50) in a range of about 1 μm to 20 μm.

16. The anode active material of claim 1, wherein the anode active material comprises:
an amount of about 40 wt % to 90 wt % of the particle; and
an amount of about 10 wt % to 60 wt % of a sum of the first material and the second materials,
the wt % based on the total weight of the anode active material.

17. An anode comprising an anode active material of claim 1.

18. An all-solid-state battery comprising an anode of claim 17.

19. A vehicle comprising an all-solid battery of claim 18.

20. A method of producing an anode active material of claim 1, comprising:
forming the particle in a predetermined shape by stacking or overlapping the plurality of the flake carbon fragments in multiple layers; and
depositing the second material on the surface of the particle and depositing the first second material.
